(19) United States
(12) Patent Application Publication
(10) Pub. No.: US 2011/0184829 A1
(43) Pub. Date: Jul. 28, 2011

(54) DENTAL PRODUCTS DISTRIBUTION SYSTEM

(76) Inventors: Amod A. Kher, Chicago, IL (US); David D. Bangert, Chicago, IL (US); Matthew J. Garrett, Waxhaw, NC (US)

(21) Appl. No.: 12/691,976

(22) Filed: Jan. 22, 2010

(51) Int. Cl. G06Q 10/00; G06Q 30/00

(52) U.S. Cl. 705/26.4

(57) ABSTRACT

Disclosed herein are systems and methods for improved dental instrument manufacturing and customer-driven dental instrument design. In one embodiment, there is provided a dental products manufacturer computer unit comprising a display; a connection to a communication network; at least one memory component; product data stored on the at least one memory component; and a plurality of program modules stored on the at least one memory component.

### FIELD OF THE INVENTIONS

The present inventions relate to dental instrument manufacturing and customer-driven dental instrument design.

### BACKGROUND

While dental instrument manufacturers have been producing goods for decades for the dental industry, the chain of supply from the manufacturer to the dental services provider has remained substantially unchanged. The well-accustomed and primary practice is for distributors to interface directly with the dental services provider or end user with the manufacturers exclusively interfacing with the distributors. As such, manufacturers receive minimal feedback from dental services providers. In turn, this isolation from the downstream end user has impeded the provision of new and improved dental products.

Moreover, the long-established marketing techniques used by distributors have proven to be an impediment to successfully marketing and introducing new dental product designs. In that regard, a majority of distributors sell products from numerous different manufacturers. Thus recognition of new products or specific products can easily be lost among the vastly larger number of existing competitive products being actively marketed by distributors, or simply overlooked by distributors in their marketing efforts.

### SUMMARY OF THE INVENTIONS

Certain embodiments of the subject inventions relate to dental instrument manufacturing and customer-driven dental instrument design. In an exemplary embodiment, a dental products manufacturer computer unit is provided that includes a display; a connection device for interacting with a communication network; at least one memory component; product data stored on the at least one memory component; and a plurality of program modules stored on the at least one memory component. The plurality of program modules may include a first program code module for displaying dental product data to a dental services provider over the communication network; a second program code module for receiving an order for a selected dental product from the dental services provider over the communication network; a third program code module for generating instructions for shipping the ordered dental product from the dental products manufacturer to the dental services provider; a fourth program code module for monitoring acceptance or return of the ordered dental product for a predetermined time period following shipment of the ordered dental product; and a fifth program code module for debiting an account of the dental services provider if no indication of return of the ordered dental product is received from the dental services provider within the predetermined time period, or if acceptance of the ordered dental product is received from the dental services provider.

Having introduced the foregoing embodiment, provided below is a detailed description of other advantageous embodiments of the present inventions.

### BRIEF DESCRIPTION OF THE DRAWINGS

FIG. 1 shows a diagram of a dental product trial coordination system embodiment implemented via a dental products manufacturer computer unit.

FIG. 2 shows a flow chart of a method embodiment.

FIG. 3 shows a diagram of a display page embodiment.

### DETAILED DESCRIPTION

Certain embodiments of the subject inventions relate to dental instrument manufacturing and customer-driven dental instrument design.

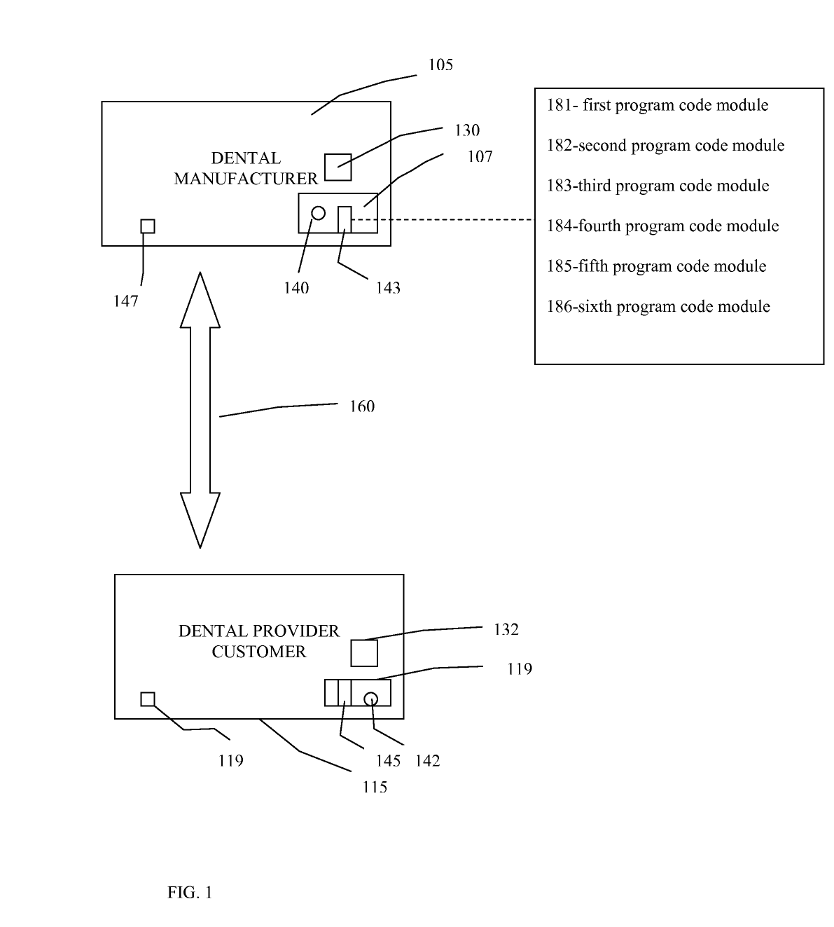

In one embodiment, as shown in FIG. 1, the subject inventions relates to a dental product trial coordination system 100 that enables a more efficient product supply conduit from a dental manufacturer 105 to a dental services provider 115, as well as enables interaction between dental products manufacturer 105 and dental services provider 115, and other dental services providers, for assisting in product design. The dental products manufacturer 105 maintains a dental instrument manufacturer computer unit 107. The dental services provider 115 maintains a computer unit 119, which is communicatingly connected to the dental product manufacturer computer unit 107. The dental products manufacturer computer unit 107 and the dental services provider computer unit 119 each have displays in association therewith 130 and 132, respectively, for displaying information. Each computer unit comprises at least one processing module 140 and 142, respectively, for processing information and each computer unit includes a memory component, 143 and 145, respectively. The memory component 143 has stored thereon dental product data concerning dental products made by dental products manufacturer 105 and a plurality of program code modules. The dental products manufacturer computer unit 107 and dental services provider computer unit 119 each include a connection device 147 and 149, respectively for interacting with a communication network 160.

In a more specific embodiment, the plurality of program code modules include a first program code module 181 for displaying dental product data to the dental services provider over a communication network; a second program code module 182 for receiving an order from the dental services provider over the communication network; a third program code module 183 for generating instructions for shipping product from the dental products manufacturer to the dental services provider; a fourth program code module 184 for monitoring a status of the shipment of the shipped product from the dental products manufacturer and/or delivery of the shipped product to the dental services provider; a fifth program code module 185 for monitoring acceptance or return of the ordered product for a predetermined time period following shipment; and a sixth program code module for debiting an account of the dental products manufacturer if no indication of return of the shipped product is received from the dental services provider within the predetermined time period.

As will be appreciated by one of skill in the art, embodiments of the present inventions may be embodied as a device or system comprising a processing module, and/or computer program product comprising at least one program code module. Accordingly, the present inventions may take the form of an entirely hardware embodiment or an embodiment combining software and hardware aspects. Furthermore, the present inventions may include a computer program product on a computer-usable storage medium having computer-usable program code embodied in the medium. Any suitable computer readable medium may be utilized including hard disks, CD-ROMs, DVDs, optical storage devices, or magnetic storage devices.

The term “processing module” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory component.

The term “memory component” may be a single memory device or a plurality of memory devices. For example, one memory device may contain product data and program code modules, or one memory device may contain product data and another memory device may contain program code modules. A memory component may pertain to read-only memory, random access memory, volatile memory, non-volatile memory, static memory, dynamic memory, flash memory, and/or any device that stores digital information.

Computer program code is provided as program code modules for carrying out specified operations of certain embodiments. The computer program code for such modules may be written in an object oriented and/or conventional procedural programming languages including, but not limited to, Java, Smalltalk, Perl, Python, Ruby, Lisp, PHP, “C”, FORTRAN, or C++. The program code modules may execute entirely on a local computer, partly on the local computer, as a stand-alone software package, partly on the local computer and partly on a remote computer communicatingly connected thereto, or entirely on the remote computer.

The dental products manufacturer computer unit may communicate with the dental services provider's computer unit through a direct telephone line, local area network (LAN) or a wide area network (WAN), or may communicate via the Internet.

A computer or “computer unit”, as used herein, is a data processing apparatus that houses at least one processing module. As described above, more than one computer may be implemented to carry out a series of readable instructions. Thus, the term “computer unit,” as used herein, may pertain to one apparatus, or two or more apparatuses for carrying out readable instructions provided as computer program code modules. However, whether computer unit pertains to one apparatus or two or more apparatuses, it is critical that such apparatus(es) be controlled by a single entity, and preferably be communicatingly connected. For example, the dental products manufacturer may have one apparatus primarily responsible for handling a dental instrument order for trial demonstration and a different apparatus for monitoring dental services provider input indicating an intent to return the demo instrument. This scenario is intended to be encompassed by the definition of computer unit so long as both computer apparatuses are accessible and maintained by dental products manufacturer, or an agent or vendor of the dental products manufacturer for such purpose.

A “dental products manufacturer” or “dental instrument manufacturer”, as used herein, refers not only the entity actively engaged in the manufacturing dental products or instruments, but also related entities operating on behalf of the manufacturer to assist in the marketing and distribution of the products and instruments. For example, dental products manufacturer also refers to affiliated entities that interface between the manufacturing entity to transfer products to dental services providers and that receive information (or perhaps also payment) from these providers.

Certain embodiments of the present inventions are described herein with reference to flowchart illustrations and/or block diagrams of methods, apparatus (systems) and computer program products according to embodiments of the inventions. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, implement the functions specified in the flowchart and/or block diagram block or blocks.

In another embodiment, the inventions pertains to an article of manufacturer that includes computer program code modules stored on a computer-readable storage medium component that can direct a computer unit or other programmable data processing apparatus to function in a particular manner. The storage medium component can be in the form of a removable component and sold separately as an article of manufacture. More specific examples (a non-exhaustive list) of a computer-readable storage medium component would include the following: a portable computer diskette, a random access memory (RAM), a read-only memory (ROM), an erasable programmable read-only memory (EPROM or Flash memory), an optical fiber, a portable compact disc read-only memory (CD-ROM), a DVD (digital video disk), or other electronic storage medium.

In certain examples of the present inventions may be embodied as a device or system comprising a processing module, and/or computer program product comprising at least one program code module. Accordingly, the present inventions may take the form of an entirely hardware embodiment or an embodiment combining software and hardware aspects, commonly known as firmware. As used herein, firmware comprises a computer program module that is embedded in a hardware device, for example a microcontroller. It can also be provided on flash memory or as a binary image file that can be uploaded onto existing hardware by a user. As its name suggests, firmware is somewhere between hardware and software. Like software, it is a computer program which is executed by a microprocessor or a microcontroller, but it is also tightly linked to a piece of hardware, and has little meaning outside of it.

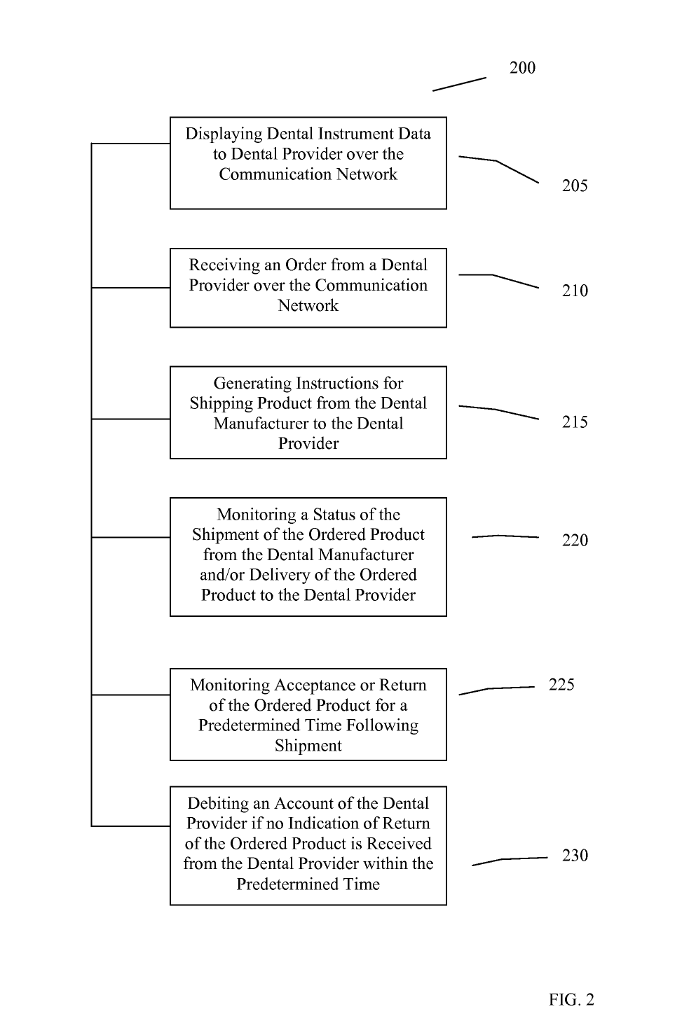

FIG. 2 shows a diagram 200 of an embodiment of the inventions. As described above, operational steps may be executed by computer program code modules. The program code modules may execute entirely on the dental products manufacturer's computer unit, partly on the dental products manufacturer's computer unit, or partly or entirely on the dental services provider's computer unit (which is a remote computer unit). Furthermore, it is noted that ‘a computer unit’ may comprise one or more computer units. For embodiment 200, it is contemplated that the program code modules execute operational steps 205-230 entirely or partly on the dental products manufacturer's and/or the dental services provider's computer unit. The embodiment 200 comprises the step 205 of displaying dental product data to the dental services provider over the communication network, e.g., the Internet. The dental services provider can access the dental product data from his or her own computer unit at a particular website, for example. The displayed data may be in any suitable format and may, for example, highlight recommended products, highlight new products, highlight specially priced products, indicate recently purchased products particular to the specific dental services provider, and the like. Upon review of the product information, the dental services provider may elect to purchase an item from the dental products manufacturer over the communication network. The dental services provider inputs or accesses user profile data, product specification data, shipping, billing, and/or payment information.

In step 210, an order is received from the dental services provider over the communication network. Thereafter, in step 215, instructions are generated for shipping product from the dental products manufacturer to the dental services provider. The instructions may be in the form of a shipping invoice or the like for the manufacturer to assemble, complete, and ship the order (shipment). In step 220, a status of the shipment of the order to the dental services provider and/or delivery of the shipment to the dental services provider is monitored for a predetermined time period. In one specific embodiment, the date of delivery of the ordered product to the dental services provider starts the predetermined time period for review and trial demonstration of the ordered product by the dental services provider. Delivery of the ordered product is typically electronically recorded remotely by shipping personnel, and may involve acceptance of receipt of the ordered product by dental services provider. In an alternative embodiment, the date of shipment from the dental products manufacturer starts the predetermined time period. In such alternative embodiment, monitoring the date that an ordered product is shipped from the dental products manufacturer is all that need be monitored. Thereafter, upon shipment and/or delivery of the ordered product, in step 225, acceptance or return of the ordered product by the dental services provider is monitored by the computer unit of the dental products manufacturer. In step 230, the dental products manufacturer will debit the dental services provider's account if no indication of return of the ordered product is received from the dental services provider within the predetermined time period, or if dental services provider inputs selection to purchase dental instrument under trial. The indication of return of the shipped product from the dental services provider to the dental products manufacturer may be in the form of input information from the dental services provider indicating an intention to return the product, a showing of the shipment of returned product, and/or actual receipt of the returned product from the dental services provider.

In one of the alternatives of the invention, the embodiment 200 further comprises receiving user information from the dental services provider over the communication network. The user information may include shipping information, billing information, purchase history, user profile information, such as the type and nature of dental services provided, and the like. The user information may be stored on the memory component of the dental products manufacturer computer unit or otherwise at any other suitable location, such as a remote server. In another embodiment, the embodiment 200 may further comprise displaying a feedback option over the communication network to the dental services provider to elicit feedback from the dental services provider on the shipped product. The feedback option may be in any suitable printed or electronic form, such as an email or the like, or may be in the form of a user-fillable field provided on the computer unit of the dental services provider, for example. In this way, the dental products manufacturer may receive useful feedback on the manufacturer's product directly from the dental services provider. Advantageously, the feedback received from the dental services provider may be useful in improving already-existing products and in designing new products.

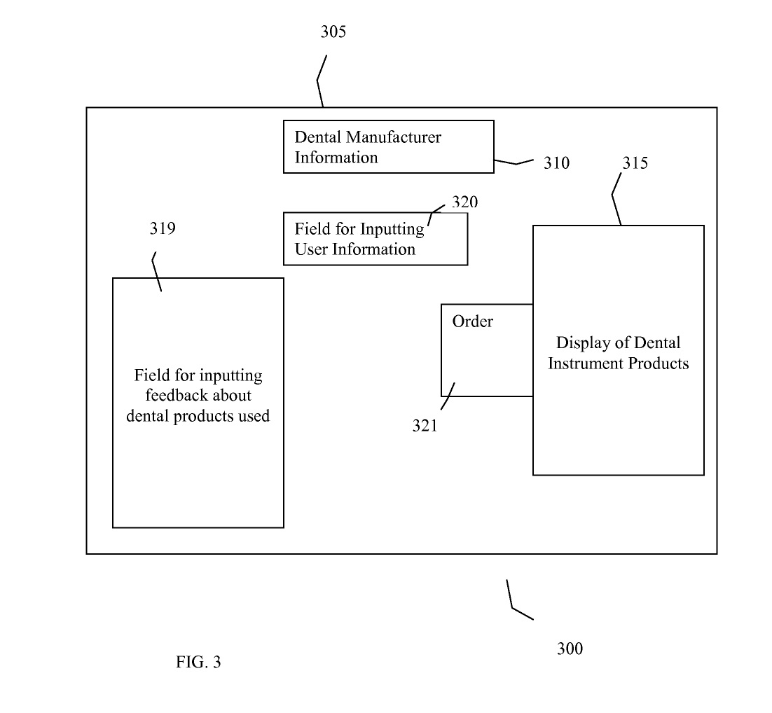

FIG. 3 shows a diagram of an exemplary embodiment 300 of a group of fields that may be provided to the display of the computer unit of the dental services provider over the communication network. One or more of the following fields and/or information is caused to be displayed on the dental services provider's display upon the dental services provider accessing a website associated with the dental products manufacturer. A page 305, typically a web-page, is caused to be displayed on dental services provider's display which provides identifying information 310 of the dental products manufacturer, as well as dental instrument products 315, offered by the dental products manufacturer that are selectable for a trial demonstration. As mentioned above, the display of dental instruments products 315, or pages hyperlinked thereto, may show advertised specials, popular products, new products, or products specifically directed to the dental services provider based on user profile information provided to the dental products manufacturer.

Optionally, shown on the page 305, or pages hyperlinked to page 305, is a field 320 for inputting user shipping information, billing information, purchase history, user profile information, such as the type and nature of dental services provided, and the like, which may be quickly recalled from the memory component of the computer unit of the dental services provider by secure password/login information as is know in the art. An order field 321 for inputting instructions to order a dental product for trial and demonstration is caused to be displayed on the dental services provider's display. In addition, a field for inputting feedback information 319 concerning a product used for a trial demonstration is provided. Such feedback information benefits the further design and modification of existing products to better meet the dental services provider's needs. Those skilled in the art, equipped with the teachings herein, will appreciate that one or two or more of the fields may be combined on a single page display or on different pages that are hyperlinked together.

While a number of embodiments of the present inventions have been shown and described herein in the present context, such embodiments are provided by way of example only, and not of limitation. Numerous variations, changes and substitutions will occur to those of skilled in the art without departing from the inventions herein. For example, the present inventions need not be limited to best mode disclosed herein, since other applications can equally benefit from the teachings of the present inventions. Accordingly, it is intended that the inventions be limited only by the spirit and scope of the appended claims in accordance with relevant law as to their interpretation.

1. A dental products manufacturer computer system comprising:
a display;
a communications connection device for interacting with a communication network;
a processor for processing data received or transmitted via the communications connection device;
memory accessible by the processor;
product data stored in memory;
a plurality of computer-readable software program modules stored in memory comprising:
a first program code module for providing dental product data to a dental services provider over the communication network;
a second program code module for receiving an order for a selected dental product from the dental services provider over the communication network;
a third program code module for generating instructions for shipping the ordered dental product from the dental products manufacturer to the dental services provider in response to the manufacturer receiving an order;
a fourth program code module for monitoring acceptance or return of the ordered dental product during a predetermined time period following shipment of the ordered dental product; and
a fifth program code module for debiting an account of the dental services provider if there is no indication of the return of the ordered dental product from the dental services provider within the predetermined time period, or if acceptance of the ordered dental product is received from the dental services provider.

2. The computer unit of claim 1, further comprising a sixth program code module for monitoring a status of the shipment of the ordered dental product from the dental products manufacturer and/or delivery of the ordered dental product to the dental services provider.

3. The dental products manufacturer computer unit of claim 1, wherein notice of the predetermined time period is set from the time of delivery of the ordered dental product to the dental services provider.

4. The dental products manufacturer computer unit of claim 1, wherein the predetermined time period is 5-30 days, or any specific amount of days included therein, starting on the date shipment of the ordered dental product is initiated.

5. The dental products manufacturer computer unit of claim 1, further comprising a seventh program code module for displaying one or more fields for receiving user profile information from the dental services provider over the communication network.

6. The dental products manufacturer computer unit of claim 1, further comprising an eighth program code module for displaying to the dental services provider a feedback field over the communication network to elicit feedback from the dental services provider regarding the ordered dental product shipped to the dental services provider.

7. The dental products manufacturer computer unit of claim 1, wherein the second program code module comprises displaying to the dental services provider over the communication network a field for inputting an order instruction.

8. A computer implemented method for delivering a dental instrument comprising:
displaying dental instrument data to the dental services provider over a communication network in response to receiving an order from the dental services provider;
receiving by a processor an order from the dental services provider over the communication network;
generating by a processor instructions for shipping product from the dental products manufacturer to the dental services provider;
monitoring by a processor a status of the shipment of the ordered dental product from the dental products manufacturer and delivery of the ordered dental product to the dental services provider;
monitoring by a processor acceptance or return of the ordered dental product for a predetermined time period following shipment;
debiting an account of the dental services provider if there is no indication of return of the ordered product from the dental services provider within the predetermined time period.

9. The computer implemented method of claim 8, wherein the predetermined time period is set based on the date of delivery of the ordered dental product to the dental services provider.

10. The computer implemented method of claim 8, further comprising receiving user profile information from the dental services provider over the communication network.

11. The computer implemented method of claim 8, further comprising displaying to the dental services provider a feedback field over the communication network to elicit feedback from the dental services provider on the ordered dental product.

12. Computer-implemented media for use with a computer systems operable by a dental products manufacturer, the computer system having a display, a communication connection device for interacting with a communication network, a processor in communication with the communication connection device and memory accessible by the processor, the media comprising:
a first program code module for providing dental product data to a dental services provider over the communication network;
a second program code module for receiving an order for a selected dental product from the dental services provider over the communication network;
a third program code module for generating instructions for shipping the ordered dental product from the dental products manufacturer to the dental services provider in response to the manufacturer receiving an order;
a fourth program code module for monitoring acceptance or return of the ordered dental product during a predetermined time period following shipment of the ordered dental product; and
a fifth program code module for debiting an account of the dental services provider if there is no indication of the return of the ordered dental product from the dental services provider within the predetermined time period, or if acceptance of the ordered dental product is received from the dental services provider;
wherein said computer-implemented media is non-transitory.

13. Computer implemented media according to claim 12 further comprising a program code module comprises displaying to the dental services provider over the communication network a field for inputting an order instruction.

14. Computer implemented media according to claim 12 further comprising a program code module for displaying to the dental services provider a feedback field over the communication network to elicit feedback from the dental services provider regarding the ordered dental product shipped to the dental services provider.

15. Computer implemented media according to claim 12 wherein the second program code module comprises displaying to the dental services provider over the communication network a field for inputting an order instruction.
